(19) United States
(12) Patent Application Publication
(10) Pub. No.: US 2014/0090847 A1
(43) Pub. Date: Apr. 3, 2014

(54) Dehydrated Gel Compositions and Methods of Using the Same

(71) Applicant: Halliburton Energy Services, Inc., Houston, TX (US)

(72) Inventors: Feng Liang, Houston, TX (US); Gary Funkhouser, Duncan, OK (US); Rajesh Saini, Cypress, TX (US); Bradley L. Todd, Duncan, OK (US)

(73) Assignee: Halliburton Energy Services, Inc., Houston, TX (US)

(21) Appl. No.: 13/629,657

(22) Filed: Sep. 28, 2012

(51) Int. Cl. C09K 8/00

(52) U.S. Cl. CPC C09K 8/00
USPC 166/305.1

(57) ABSTRACT

Methods and compositions using gel compositions in treatment fluids employed in subterranean operations. A method includes providing a degradable gel precursor as a solid or dispersion in which substantially all the water has been removed, the degradable gel precursor being formed by a combination of a monomer and a degradable crosslinking agent of formula R¹-[A]-[R³]—[B]—R², wherein R¹ and R² may be the same or different, and includes at least one group selected from a substituted or unsubstituted ethylenically unsaturated group, N-acryloyl, O-acryloyl, vinyl, allyl, maleic anydride, a derivative thereof, and a combination thereof, A and B comprise optional bridging units, and R³ comprises a degradable group or polymer, the method including placing the degradable gel precursor in an aqueous base fluid thereby forming a treatment fluid which includes a degradable gel, and placing the treatment fluid into a subterranean formation.

### BACKGROUND

The present invention relates to methods and compositions useful in subterranean operations, and, more specifically, to gel compositions and their use in treatment fluids employed in subterranean operations.

Viscosified treatment fluids employed in subterranean operations are often aqueous-based fluids comprising gelling agents. Such viscosified treatment fluids are often referred to as “gels.” The term “gel” as used herein refers to a semi-solid, jelly-like state assumed by some colloidal dispersions. The term “colloidal dispersion” as used herein refers to a system in which finely divided particles are dispersed within a continuous medium. The gelling agents used to form gels often comprise macromolecules such as biopolymers or synthetic polymers. Common gelling agents include, for example, galactomannan gums, cellulosic polymers, and other polysaccharides. As used herein, the term “treatment fluid” refers to any fluid that may be used in a subterranean application in conjunction with a desired function and/or for a desired purpose. The term “treatment fluid” does not imply any particular action by the fluid or any component thereof.

Numerous viscosified treatment fluids include cross-linked gelling agents that are cross-linked through a crosslinking reaction between gelling agent molecules and a suitable crosslinking agent. These crosslinking agents may comprise a metal, a metal complex, or a metalloid, collectively referred to herein as “metal(s).” Non-limiting examples include compounds containing boron, aluminum, antimony, zirconium, magnesium, or titanium. Generally, the metal of a crosslinking agent interacts with at least two gelling agent molecules to form a crosslink between them, thereby forming a cross-linked gelling agent. The term “cross-linked gelling agent” as used herein refers to a gelling agent that contains, on average, at least one crosslink per molecule. This may be indicated when G′>G″ at certain frequencies. G′ is the storage component and G″ is the loss components. G′ represents the characteristic elastic modulus of the system and G″ measures the viscous response. The elastic modulus (or G′) of a gel is an accepted standard measure of a gel's elasticity as determined by small-strain oscillatory rheology according to Equation (1) and the viscous modulus G″ is given by Equation (2):

G′(ω)=[τₒ(ω)/γₒ] cos(δ) (1)

G″(ω)=[τₒ(ω)/γₒ] sin(δ) (2)

where G′(ω) is the frequency-dependent elastic modulus; G″(ω) is the frequency-dependent viscous modulus; τₒ(ω) is the frequency-dependent maximum stress (opposing force caused by the deformation divided by the area to which the force is applied), γₒ is the strain amplitude (ratio of the change caused by the stress to the original state of the gel), ω is the frequency of the oscillation, and δ is the phase angle.

Pills are often used in subterranean applications. The term “pill” as used herein refers to a relatively small volume of a specially prepared fluid placed or circulated in the well bore. Fluid pills are commonly prepared for a variety of special functions, such as a sweep pill prepared at high viscosity to circulate around the well bore and pick up debris or well bore fill. In counteracting lost-circulation problems, a lost-circulation pill prepared with flaked or fibrous material is designed to plug the perforations or formation interval losing the fluid. A “fluid-loss control pill” is a gelled fluid that is designed or used to provide some degree of fluid-loss control. Through a combination of viscosity, solids bridging, and cake buildup on the porous rock, these pills oftentimes are thought to seal off portions of the formation from fluid loss. They may also generally enhance filter-cake buildup on the face of the formation to inhibit fluid flow into the formation from the well bore. Pills often may involve a relatively small quantity (e.g., less than 200 bbl) of a special blend of a drilling fluid to accomplish a specific task that a regular drilling fluid cannot perform. Examples include high-viscosity pills to help lift cuttings out of a vertical well bore; freshwater pills to dissolve encroaching salt formations; pipe-freeing pills to destroy filter cake and relieve differential sticking forces; and lost circulation material pills to plug a thief zone.

Typically, pills comprise an aqueous base fluid and a high concentration of a gelling agent polymer, and, sometimes, bridging particles, like graded sand, potassium salts, or sized calcium carbonate particles. An example of a commonly used pill contains high concentrations (e.g., 100 to 150 lbs/1000 gal) of a modified hydroxyethylcellulose (“HEC”). Some other gelling agent polymers that have been used include guar, guar derivatives, carboxymethylhydroxyethylcellulose (“CMHEC”), and starch.

As an alternative to linear polymeric gels for pills, cross-linked gels are often used. Crosslinking the gelling agent polymer is thought to create a gel structure that is better able to support solids and possibly even provide fluid-loss control. Further, cross-linked pills are thought to invade the formation face to a lesser extent to be desirably effective. To crosslink these gelling agents, a suitable crosslinking agent that comprises polyvalent metal ions is often used. Complexes of aluminum, titanium, boron, and zirconium are common examples.

A disadvantage associated with conventional cross-linked gelling agents is that any resultant gel residue is often difficult to remove from the subterranean formation once the treatment has been completed. For example, in fracturing treatments, the cross-linked gels used are thought to be difficult to completely clean up with conventional breakers, such as oxidizers or enzymes. Any remaining gel residue can be difficult and time-consuming to remove from the subterranean formation. This is problematic because the gel residue can diminish the permeability of the formation by, inter alia, blocking pore throats and other fluid passageways. If the formation permeability is not restored to near its original level, production levels can be significantly reduced. This gel residue often requires long cleanup periods. Moreover, an effective cleanup usually requires fluid circulation to provide high driving force, which is thought to allow diffusion to take place to help dissolve the concentrated buildup of the gel residue. Such fluid circulation, however, may not be feasible. Additionally, in lower temperature wells (i.e., those below about 80° F./26.67° C.), it is often difficult to find an internal breaker for the viscosified treatment fluids that will break the gel residue effectively. The term “break” (and its derivatives) as used herein refers to a reduction in the viscosity of the viscosified treatment fluid, for example by the breaking or reversing of the crosslinks between polymer molecules or some reduction of the size of the gelling agent polymers. No particular mechanism is implied by the term. Another method of cleaning up gel residue is to spot of a strong acid (e.g., 10% to 15% hydrochloric acid) with coiled tubing; however this cleanup method is expensive and can result in hazardous conditions.

Developments in cleaning and removing filter cakes left by fluid loss control additives and pills include materials that degrade under acidic conditions such as calcite. While such techniques can be effective, they require good contact between the acid-generating compound and the acid-soluble compound, which is often difficult to achieve.

Another problem presented by cross-linked gelling agent systems with respect to cleanup is that high temperature formations (e.g., bottom hole temperatures of about 200° F./93.33° C. or greater) often require crosslinking agents that are more permanent, and thus harder to break. Examples of such more permanent crosslinking agents include transition metal crosslinking agents. Such crosslinking agents can make cleanup of the resulting gel residue more difficult.

Some of the above-mentioned issues have been addressed by way of programmed degradable gel systems. For example, chopped degradable crosslinked polyacrylamide gels have been employed as diverting agents in sand control and fracturing applications. These degradable gels may comprise organic crosslinking groups such as esters, phosphate esters, amides, acetals, ketals, orthoesters, carbonates, anhydrides, silyl ethers, alkene oxides, ethers, imines, ether esters, ester amides, ester urethanes, and carbonate urethanes, for example. Most of these gels comprise hydrolyzable groups that slowly degrade in an aqueous environment. The gels may even degrade in the presence of the residual water within the gels on standing at room temperature. While the degradability of these gels may be useful to improve cleanup, it comes at the cost of reduced shelf life due to premature hydrolytic degradation, raising issues in both storage and transportation of these gels.

### SUMMARY OF THE INVENTION

The present invention relates to methods and compositions useful in subterranean operations, and, more specifically, to gel compositions and their use in treatment fluids employed in subterranean operations.

In some embodiments, the present invention provides a method comprising providing a dehydrated gel, wherein the dehydrated gel is formed by a combination of a monomer, and a degradable crosslinking agent of formula R¹-[A]-[R³]—[B]—R², wherein R¹ and R² may be the same or different, and comprise at least one group selected from the group consisting of: a substituted or unsubstituted ethylenically unsaturated group, N-acryloyl, O-acryloyl, vinyl, allyl, maleic anydride, a derivative thereof, and a combination thereof, A and B comprise optional bridging units, and R³ comprises a degradable group or polymer, the method comprising placing the dehydrated gel in an aqueous base fluid thereby forming a treatment fluid comprising a degradable gel, and placing the treatment fluid into a subterranean formation.

In other embodiments, the present invention provides a method comprising providing a dehydrated gel, wherein the dehydrated gel is formed by a reaction of a monomer and a degradable crosslinking agent that includes at least one degradable group and two unsaturated terminal groups to provide a crosslinked gel product and dehydrating the crosslinked gel product, the method including placing the dehydrated gel in an aqueous base fluid thereby forming a treatment fluid comprising a degradable gel, placing the treatment fluid into a subterranean formation, and allowing the degradable gel to degrade thereon.

In still other embodiments, the present invention provides a method comprising placing a dehydrated gel in an aqueous base fluid to provide degradable crosslinked gelled particles, wherein the dehydrated gel is formed by a reaction comprising a monomer, and a degradable crosslinking agent that includes at least one degradable group and two unsaturated terminal groups, the method comprising introducing the degradable crosslinked gelled particles into a subterranean formation, and allowing the degradable crosslinked gelled particles to reduce the loss of fluid to a portion of the subterranean formation.

The features and advantages of the present invention will be readily apparent to those skilled in the art upon a reading of the description of the preferred embodiments that follows.

### DETAILED DESCRIPTION

The present invention relates to methods and compositions useful in subterranean operations, and, more specifically, to gel compositions and their use in treatment fluids employed in subterranean operations.

The dehydrated gels of the present invention are advantageously provided as “dry” gel precursors that may provide improved shelf life. As substantially water-free materials, the hydrolytic processes that shorten shelf life may thus be reduced. Additionally, the dehydrated gels may also benefit from reduced weight when stored in solid form yet the dehydrated gels of the invention may be readily reconstituted into hydrated gel form and subsequently used on site. On a large scale, the reduced weight of solid dehydrated gels may have a substantial impact on, for example, transport-related costs.

The “dry” dehydrated gels may also be provided as dispersions in non-aqueous solvent systems that may afford protection from exposure to environmental moisture. For example, dispersions may be provided in hydrophobic solvents that are readily kept dry. Solvents used in connection with dispersed dehydrated gels may be the same solvents as those used during synthesis. For example, when azeotropic distillation is employed as the drying method, one may include an additional solvent component, along with a high-boiling solvent that was used during synthesis, to generate a low-boiling azeotrope to remove the water from the material. This drying strategy provides for streamlined processing of dehydrated gels.

The dehydrated gels of the present invention can be reconstituted into hydrated degradable gels and used in any application in which it is desirable to have a degradable gel. Suitable subterranean applications in which degradable gels can be used include pills (such as fluid loss control pills), fracturing fluids, temporary plugs (for example, in tubing), diverting agents, temporary sealing materials (e.g., in screens), drilling fluids, and drill-in fluids. They may be also used as fluid loss control agents when made in smaller forms.

In a subterranean application context, one of the desirable features of the degradable gels is that after a delay period, they degrade as a result of the degradation of their acid-degradable crosslinks, which allows the gel to break up into smaller components that may not negatively impact well productivity or the flow of fluids through the rock. This time-triggered self-degradation may allow for the use of some equipment to be avoided (e.g., coiled tubing to spot acid for gel residue cleanup), thus reducing the overall cost of a well treatment.

Stimuli that may lead to the degradation of the reconstituted dehydrated gels of the present invention may include any change in the condition or properties of the gel, such as a change in pH (e.g., caused by the buffering action of the rock or the decomposition of materials that release chemicals such as acids), or a change in the temperature of the fluid (e.g., caused by the contact of the fluid with the formation temperature). In some embodiments, the stimuli may be a function of the rock formation; for example, at least in some circumstances, the chemistry of the rock formation may affect the degradation of the gel, thus, increasing the reliability of the application. In some embodiments, a change in pH may be effected by introducing acid into the formation from the surface by an operator.

The continuous rate of degradation of the degradable gels may be affected by pH and temperature. For instance, their acid degradable crosslinks may degrade more rapidly as their environment becomes more acidic, being relatively stable at higher pHs (e.g., a pH of above about 10) but relatively unstable at lower pHs (e.g., a pH of less than about 9). Or, at higher temperatures the crosslinks may degrade more quickly; at lower temperatures, less quickly. Some gels may be sensitive to both pH and temperature. Also, in some embodiments, at a pH of about 13 or greater with heat, the crosslinks may degrade at an appreciable level. Thus, a pH change in the treatment fluid can trigger the degradable crosslinks in the degradable gels to degrade. Once the degradable crosslinks degrade, the degradable gel breaks up into smaller molecules that, in some embodiments, may be water soluble or, at least, water dispersible. In subterranean applications, these smaller molecules should not represent as much as a hindrance to produced fluids. The terms “degrade” and “degradation” (and their derivatives) as used herein refer to the continuous loss of gel properties, characterized by a decrease in the elastic modulus (G′) of the gelled system.

To form the dehydrated gels of the present invention, degradable crosslinking agents may be used to crosslink gelling agents that are formed from reactions comprising “ethylenically unsaturated monomers” that include substituted or unsubstituted ethylenically unsaturated monomer groups, vinyl groups, allyl groups, acrylate groups, maleimide groups, and acryloyl groups, and mixtures thereof. In certain embodiments, suitable gelling agents that may be used in conjunction with the degradable crosslinking agents of the present invention are made from reactions comprising ethylenically unsaturated monomers of the general formula CH₂═CXY, wherein X and Y may be hydrogen, alkyls, aryls, alkoxy, carboxylic acids, amides, acetamides, esters, ethers, and the like. After formation of the “wet” gel, dehydration is effected via azeotropic distillation, heating, placing under vacuum, freeze-drying or any combination of these techniques for water removal.

It should be noted that when “about” is provided at the beginning of a numerical list, “about” modifies each number of the numerical list. As used herein, the term “dehydrated” means that the gel contains an amount of water ranging from a lower limit of about 0.01%, 0.02%, 0.03%, 0.05%, 0.1%, 0.2%, 0.3%, 0.4%, 0.5%, 0.6%, 0.7%, or 0.8% to an upper limit of about 0.6%, 0.7%, 0.8%, 0.9%, or 1% water by weight, and wherein the percentage of water may range from any lower limit to any upper limit and encompass any subset between the upper and lower limits. Some of the lower limits listed above are greater than some of the listed upper limits, one skilled in the art will recognize that the selected subset will require the selection of an upper limit in excess of the selected lower limit. Any degree of dehydration may be provided in the dehydrated gels of the invention with the proviso that the residual amount of water remaining does not appreciably reduce the shelf life of the dehydrated gel. In some embodiments, the amount of residual water allows for a dehydrated gel having a shelf life of about 6 months, about 1 year, about 2 years, 3 years, about 4 years, or about 5 years, including any time period in between.

In some embodiments, the present invention provides a method comprising providing a dehydrated gel wherein the degradable gel precursor is formed by a combination of a monomer, and a degradable crosslinking agent of formula:

R¹-[A]-[R³]—[B]—R²

wherein R¹ and R² may be the same or different, and comprise at least one group selected from the group consisting of: a substituted or unsubstituted ethylenically unsaturated group, N-acryloyl, O-acryloyl, vinyl, allyl, maleic anydride, a derivative thereof, and a combination thereof. Wherein R³ comprises a degradable group or polymer. And, wherein A and B comprise independent optional bridging units. The method comprises placing the degradable gel precursor in an aqueous base fluid to form a treatment fluid comprising a degradable gel, and placing the treatment fluid into a subterranean formation.

In some embodiments, the monomer component comprises at least one selected from the group consisting of an ethylenically unsaturated monomer of the general formula: CH₂═CXY, wherein X and Y may be hydrogen, methyl, an alkoxy amide group, or an acetamide group; an ionizable monomer; 1-N,N-diethylaminoethyl methacrylate; diallyldimethylammonium chloride; 2-acrylamido-2-methylpropanesulfonic acid; acrylic acid; sodium 2-acrylamido-2-methylpropanesulfonate; acrylic acid; sodium acrylate; an allylic monomer; diallyl phthalate; diallyl maleate; allyl diglycol carbonate; vinyl formate; vinyl acetate; vinyl propionate; vinyl butyrate; itaconic acid; acrylamide; methacrylamide; methacrylonitrile; acrolein; methyl vinyl ether; ethyl vinyl ether; vinyl ketone; ethyl vinyl ketone; allyl acetate; allyl propionate; diethyl maleate; a vinyl amide; N-vinylpyrrolidone, N-vinylformamide, N-vinylacetamide, N-vinylcaprolactam; a derivative thereof; and any combination thereof.

In some embodiments, R³ comprises at least one group selected from the group consisting of: an ester, a phosphate ester, an amide, an acetal, a ketal, an orthoester, a carbonate, an anhydride, a silyl ether, an alkene oxide, an ether, an imine, an ether ester, an ester amide, an ester urethane, a carbonate urethane, an amino acid, a derivative thereof, and any combination thereof.

In the embodiments in which A, B, or A and B are present, they each comprise, independently, at least one group selected from the group consisting of: a peptide chain, an aromatic substituent, an alkyl group, an alkylene oxide group, a polar group, and a derivative thereof.

In some embodiments, the crosslinking agent is synthesized from diketene acetals or multiketene acetals by the addition of an alcohol having acrylic, vinylic, or allylic groups. In some such embodiments, the alcohol comprises at least one alcohol selected from the group consisting of: hydroxyethyl acrylate; hydroxypropyl methacrylamide; hydroxybutyl methacrylate; and glycerol monomethacrylate.

In some embodiments, the crosslinking agent is formed by a reaction comprising an alcohol that contains a vinyl, allyl, or acryloyl group and a low molecular weight orthoester of Formula I:

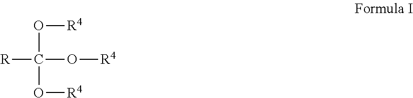

wherein R is H, CH₃, or C₂H₅, and each R⁴ is, independently, an alkyl group having from about 1 to about 6 carbon atoms. Note that while commonly referred to as an “orthoester,” chemically the material is considered an ether as it lacks an oxygen double-bonded to a carbon. In some embodiments, the crosslinking agent is water soluble.

In some embodiments, an elastic modulus of the resultant gel particles at a first time is greater than the elastic modulus of the gel particles at a later second time due to degradation of the degradable gel. For example, the elastic modulus may be altered as a function of decreased crosslinking upon degradation. In some embodiments, the degree of change in the elastic modulus can be carefully modulated by programmed breakdown of the gel at specific temperatures, pH, or combinations thereof.

In some embodiments, the present invention provides methods comprising providing dehydrated gels as solids or dispersions in which substantially all the water has been removed wherein the dehydrated gels are formed by reacting a monomer and a degradable crosslinking agent that includes at least one degradable group and two unsaturated terminal groups to provide a crosslinked gel product and dehydrating the crosslinked gel products, placing the substantially dehydrated gels in aqueous base fluids thereby forming treatment fluids comprising degradable gels, placing the treatment fluids into subterranean formations, and allowing the degradable gels to degrade.

In some embodiments, methods of the invention further comprise reducing the pH of the treatment fluids before allowing the degradable gels to degrade. In some embodiments, methods of the invention further comprise subjecting the treatment fluids to a temperature change before allowing the degradable gels to degrade. In some embodiments, methods of the invention further comprise a combination of pH and temperature changes before allowing the degradable gels to degrade.

In some embodiments, the present invention provides methods of providing fluid loss control in a subterranean applications comprising placing dehydrated gels, as solids or dispersions in which substantially all the water has been removed, in aqueous base fluids to provide degradable crosslinked gelled particles, wherein the degradable gel precursor is formed by a reaction comprising a monomer, and a degradable crosslinking agent that includes at least one degradable group and two unsaturated terminal groups, the method further comprising introducing the degradable crosslinked gelled particles into a subterranean formation, and allowing the degradable crosslinked gelled particles to reduce the loss of fluid to a portion of the subterranean formation.

The dehydrated gels employed in methods of the invention are accessed by removing water from the newly formed gels of the crosslinking step. In some embodiments, removing water may be performed by way of azeotropic distillation. In some such embodiments, the solvent utilized may be a hydrophobic solvent, such as a hydrocarbon. Suitable hydrocarbons may include, without limitation, pentane, hexane, heptane, isooctane, benzene, toluene, or any other hydrocarbon solvent or combination of solvents known to form azeotropes with water. In some embodiments, the solvent employed in azeotropic removal may be readily volatilized. In some embodiments, the solvent employed in azeotropic removal may allow for freeze-drying. In some embodiments, freeze-drying may be accomplished in the absence of an azeotropic cosolvent. In some embodiments, freeze-drying may be achieved under reduced pressure while providing external cooling. In some embodiments, water may be removed under reduced pressure, i.e. under vacuum. In some embodiments, water may be removed under reduced pressure while heating. In some embodiments, water may be removed by azeotropic distillation under reduced pressure. In some embodiments, water may be removed by heating alone.

The present invention relates to methods and compositions useful in subterranean operations, and, more specifically, to dehydrated gel compositions and their reconstituted degradable gel form used in treatment fluids employed in subterranean operations. Suitable examples include, but are not limited to, ionizable monomers (such as 1-N,N-diethylaminoethylmethacrylate), diallyldimethyl-ammonium chloride, 2-acrylamido-2-methylpropanesulfonate, and acrylic acid, and mixtures or derivatives thereof; allylic monomers (such as di-allyl phthalate, di-allyl maleate, allyl diglycol carbonate, and the like); vinyl formate, vinyl acetate, vinyl propionate, vinyl butyrate, crotonic acid, itaconic acid, acrylamide and its derivatives, methacrylamide, methacrylonitrile, acrolein, methyl vinyl ether, ethyl vinyl ether, vinyl ketone, ethyl vinyl ketone, allyl acetate, allyl propionate, and diethyl maleate; and mixtures or derivatives thereof. The term “group” as used herein refers to a combination of bonded atoms.

The crosslinking reactions may be carried out via a copolymerization reaction. The reconstituted degradable gel precursors may be suitable for use at temperatures that they will encounter during subterranean operations. One of ordinary skill in the art, with the benefit of this disclosure, may be able to determine the appropriate degradable crosslinking agent to use to form the degradable gel based on, among other things, bottom hole temperatures that may be encountered. For instance, under moderately acidic conditions (pH of about 3), the stability of amides, ketals, and orthoesters is thought to decrease, in the order of amides>ketals>orthoesters.

The polymerization of the monomers to synthesize dehydrated gels may be effected by any known methods such as free radical polymerization, cationic polymerization, anionic polymerization, condensation polymerization, coordination catalyst polymerization, and hydrogen transfer polymerization. The polymerization may be done in any manner, e.g., solution polymerization, precipitation polymerization, suspension polymerization, emulsion polymerization, and bulk polymerization; these are known methods described in the literature. Which particular method to use may depend on, inter alia, the gelling agent monomer and the crosslinking agent used, and also the application for the resultant gel. In some embodiments, the degradable crosslinking agent may be added to the gelling agent at the time of polymerization of the gelling agent monomers. This polymerization may be conducted in any manner suitable. Suitable temperatures and other conditions are well known.

Gelling agent monomers may be present in an amount of from about 1% to about 50% of the solution, and the crosslinking agent may be present in an amount of from about 0.1% to about 15% of the monomer concentration. A preferred amount of the crosslinking agent may be from about 0.5% to about 10% of the monomer concentration. In other embodiments, a degradable crosslinking agent may be added to the gelling agent after polymerization.

The degradable crosslinking agents may include at least one degradable group, and two unsaturated terminal groups. In some embodiments, the crosslinking agents of the present invention can be described by the following general formula: R¹-[A]-[R³]—[B]—R² wherein R¹ and R² represent two groups which may be the same or different, and are selected from substituted or unsubstituted ethylenically unsaturated groups, N-acryloyl, O-acryloyl, vinyl, allyl, and maleimide, and derivatives or combinations thereof, that are capable of polymerizing with the monomers of the gelling agents. A and B optionally are extra groups to aid compatibility of the crosslinking groups with the reaction solvent. A and B may be bridging units that are relatively unreactive with the other molecules to be cross-linked, and may have functionalities that are compatible with the terminal groups. A and B may include peptide chains, aromatic substituents, alkyl chains, or polar groups to make the crosslinking agent compatible with the reaction solvent and monomers forming the gelling agent. A and B may be independently tailored to change the properties of a particular embodiment of the crosslinking agents of the present invention, e.g., to make it soluble in water or organic solvents, which may be important depending on the polymerization medium. R³ can be a degradable group or a polymer.

In other embodiments, the degradable group may include any degradable group or plurality of groups including, but not limited to, esters, phosphate esters, amides, acetals, ketals, orthoesters, carbonates, anhydrides, silyl ethers, alkene oxides, ethers, imines, ether esters, ester amides, ester urethanes, carbonate urethanes, and amino acids, and derivatives or combinations thereof. The choice of the degradable group may be determined by pHs and temperatures, the details of which are available in known literature sources. The unsaturated terminal group may include substituted or unsubstituted ethylenically unsaturated groups, vinyl groups, allyl groups, or acryloyl groups, which are capable of undergoing polymerization with the above-mentioned gelling agents to form cross-linked degradable gels. Examples include, but are not limited to, unsaturated esters such as acrylates, methacrylates, and butyl acrylates; amides such as acrylamide; and ethers such as vinyl ether; and combinations thereof. In one embodiment, a degradable crosslinking agent comprises a degradable crosslink and two vinyl groups.

Some embodiments of these crosslinking agents of the present invention are sensitive to changes in pH, such as orthoester-based embodiments, acetal-based embodiments, ketal-based embodiments, and silicon-based embodiments. Generally speaking, at room temperature, the orthoester-based embodiments may be stable at pHs of above 10, and may degrade at a pH below about 9; the acetal-based embodiments may be stable at pHs above about 8 and may degrade at pH below about 6; the ketal-based embodiments may be stable at pHs of about 7 and may degrade at a pH below 7; and the silicon-based embodiments may be stable at pHs above about 7 and may degrade faster in acidic media. Thus, under moderately acidic conditions (pH of around 3), the relative stability of these groups may decrease in the following order: amides>ketals>orthoester. At higher well bore temperatures, the more stable crosslinking groups contain amides or ethers and would be preferred over other choices including esters, acetals, and ketals.

Also, in some embodiments, the crosslinking agents may be sensitive to changes in temperature. Thus, where R³ (in the formula above) is an ester group, the cross-linking agent may degrade at 170° F./76.67° C. in about 10 hours at pH 10.8, whereas when R³ is an amide, the cross-linking agent may be stable for several days at pH 10.8 and 185° F./85° C.

The ester embodiments of the crosslinking agents may be described as formed when any di, tri, or more functional alcohols react with unsaturated acids or acid chlorides. Examples include: poly(ethylene glycol)diacrylate, poly(ethylene glycol)dimethacrylate, poly(propylene glycol)diacrylate, and hexanediol diacrylate. Some ether embodiments include: poly(ethylene glycol)divinyl ether, and 1,4-cyclohexane dimethanol divinyl ether; some amide embodiments include poly(ethylene glycol)bisacrylamide, and N,N′-(1,2 dihydroxyethylene)bisacrylamide. N,O-dimethacryloylhydroxylamine is a relatively acid stable cross-linking agent that may decompose more rapidly above pH 6.5, when formed as described U.S. Pat. No. 5,124,421, the entire disclosure of which is hereby incorporated by reference.

An example of a crosslinking agent suitable for use in the present invention may be a short chain poly(lactic acid) substituted with an acrylate group on the two ends of the chain.

In some embodiments, suitable orthoester crosslinking agents may be synthesized from diketene acetals or multiketene acetals by the addition of two (in the case of a diketene acetal) or more mole equivalents (in the case of a multiketene acetal) of an alcohol containing ethylenically unsaturated monomers, acrylic groups, vinylic groups, or allylic groups that are suitable for polymerization with the monomers already described.

Examples of suitable diketene, or multiketene, acetals may be synthesized as described in U.S. Pat. No. 4,304,767, U.S. Pat. No. 6,822,000, and United States Patent Application Publication No. 2004/0096506, the entire disclosures of which are incorporated herein by reference. In one embodiment, as illustrated below in Scheme 1, a diketene acetal may be synthesized by reacting pentaerythritol and chloroacetaldehyde dimethyl acetal in the presence of p-toluenesulfonic acid or methanesulfonic acid to afford 2, which on dehydrohalogenation in presence of t-butoxide in t-butanol afford diketene acetal 3, and a suitable orthoester crosslinking agent 4 may be synthesized by reacting the resultant diketene acetal with two mole equivalent of the N-methylolacrylamide in the presence of a small amount of iodine dissolved in pyridine. In some embodiments, the orthoester crosslinking agent may be synthesized by mixing the alcohol containing ethylenically unsaturated groups with the diketene acetal, without the aid of an iodine/pyridine catalyst, provided the alcohols and diketene acetals are extremely pure.

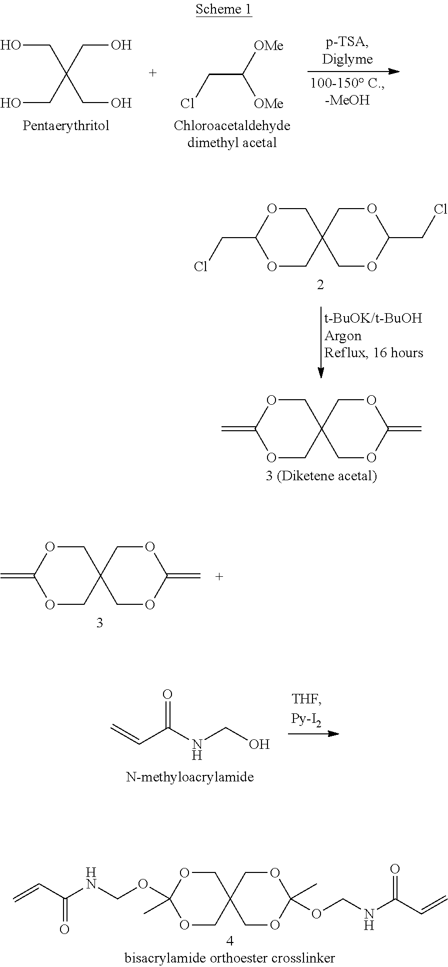

Suitable degradable crosslinking agents may be made to have a balance between hydrophobic or hydrophilic characteristics by using various kinds of mono alcohols. A water soluble degradable crosslinking agent may be desirable, for instance, in a reaction of a gelling agent polymer in an aqueous medium and an organic solvent soluble crosslinking agent for the polymerization reaction in a nonaqueous medium. In the design of the bisacrylamide orthoester crosslinking agent, for example the acryloyl alcohol, can be chosen based on certain factors, such as ease of synthesis, solubility, and the type of hydrogel or microparticle desired. The addition of N-methylolacrylamide to diketene acetal 3 may produce a water soluble crosslinking agent, which may be more useful in an aqueous polymerization reaction. The crosslinking agent can also be made to be soluble in organic solvents by incorporation of additional alkyl or methylene groups in the chain of the molecule. An orthoester crosslinking agent prepared by the addition of 2-hydroxyethyl methacrylate to diketene acetal 3 resulted in the formation of a water insoluble crosslinking agent 5 (Scheme 2). The crosslinking agent 5 contains an ester group which may undergo hydrolysis at higher pH, and may be more suitable for lower temperature applications.

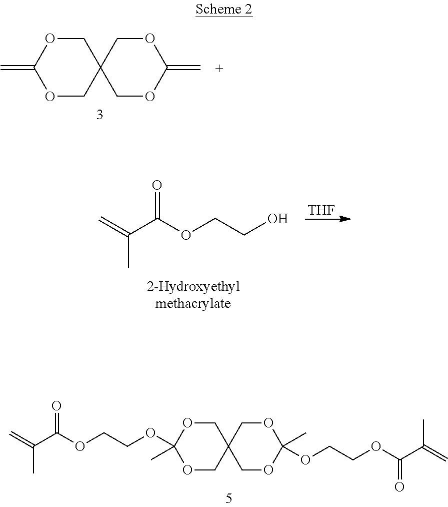

Alcohols that contain ethylenically unsaturated groups can be any alcohol capable of reacting with the diketene acetal or multiketene acetal to form an orthoester crosslinking agent. Exemplary alcohols suitable as reactants include hydroxyethyl acrylate; hydroxypropylmethacrylamide; hydroxybutyl methacrylate; and glycerol monomethacrylate.

An example of a bisacrylamide orthoester crosslinking agent is shown in Scheme 3 which may be used to form (e.g., by free radical polymerization reaction) an acrylamide cross-linked polymer, which may then degrade according to the reaction sequence shown in Scheme 3, (however, one may note that at higher pHs (e.g., about 13) the bisacrylamide orthoester crosslinking agent may degrade by another mechanism, e.g., through amide bond cleavage):

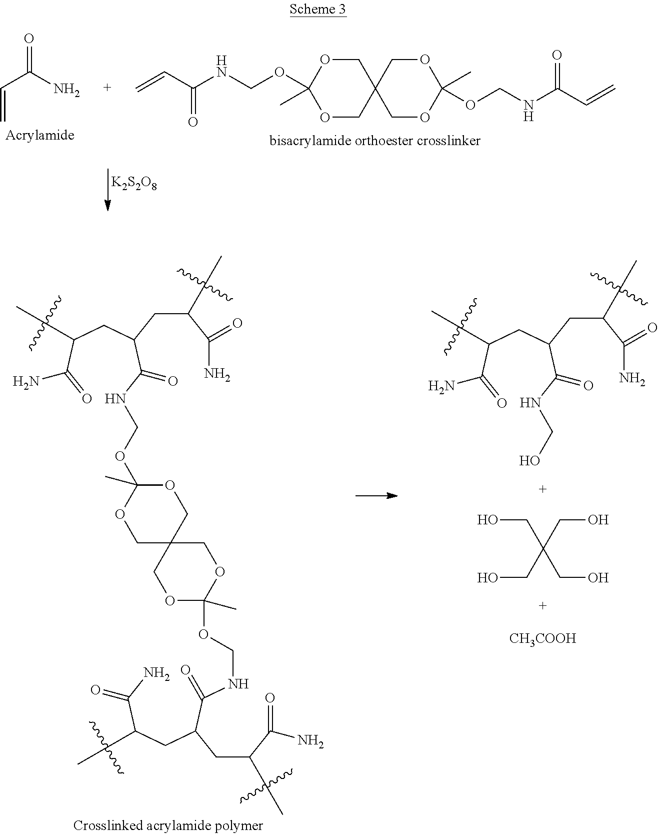

In certain embodiments, suitable orthoester crosslinking agents may be synthesized by reacting, in one or more steps, a low molecular weight orthoester of Formula I, with an alcohol that contains ethylenically unsaturated groups in accordance with the exemplary scheme illustrated in Scheme 4.

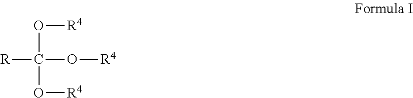

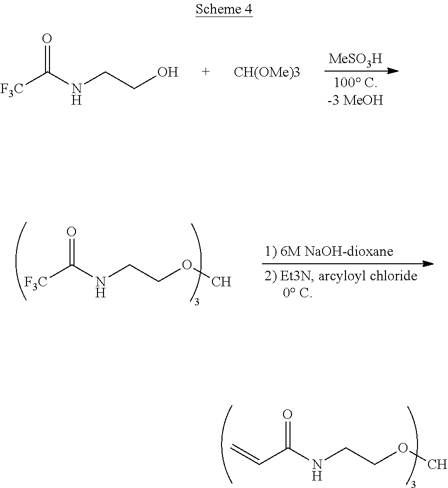

wherein R in Formula I is H, CH₃, or C₂H₅, and R₄ is an alkyl group having from about 1 to about 6 carbon atoms. Examples of suitable low molecular weight orthoesters of Formula I include, but may not be limited to, trimethyl orthoformate, trimethyl orthoacetate, triethyl orthoformate, triethyl orthoacetate, tripropyl orthoformate, and tripropyl orthoacetate. Low molecular weight orthoesters may be used due to the ease of transesterification undergone by these molecules with high molecular weight alcohols. Because the trimethyl orthoformate molecule has three positions that may be substituted by the reactants, the product of the reaction depicted in Scheme 4 can be made by either attaching two groups or three groups.

Suitable crosslinking agents also may be silicon-based. An example is an acid labile dimethacrylate crosslinking agent shown in Scheme 5. Dimethyldi(methacryloyloxy-1-ethoxy)silane may be synthesized by reaction of 2-hydroxyethyl methacrylate (HEMA) and dichlorodiethyl silane in the presence of triethylamine, which can be copolymerized with the gelling agents of the present invention to form cross-linked degradable gels. These cross-linked gels can be easily broken in acidic media.

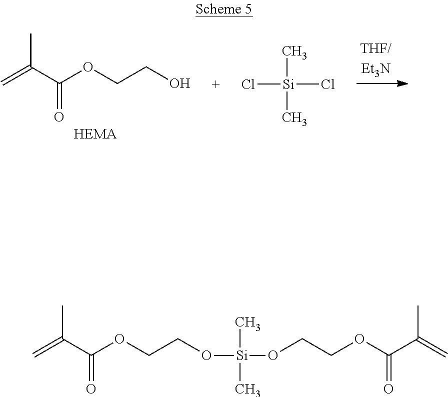

While the degradable gels of the present invention included in the treatment fluids of the present invention are generally degradable, it may be desired, in some embodiments, to achieve rapid degradation. Therefore, in some embodiments, to facilitate the degradation of the cross-linked polymer, and thus degrade the gel or gel particles, the pH of the treatment fluid may be decreased at a desired time. For example, in an orthoester cross-linked embodiment at a pH of about 8 or less, the orthoester crosslinks may degrade at reasonable rates. In subterranean applications, the buffering action of the formation together with temperature may, in some embodiments, provide the desired degradation.

Acetal crosslinking agents can be achieved in many ways suitable for crosslinking with the gelling agents that can be hydrolyzed in mild acidic conditions. Suitable crosslinking agents based on bisacryloyl acetal moiety are described in U.S. Pat. No. 7,056,901, the entire disclosure of which is herein incorporated by reference. These crosslinking agents can be tuned to be water-soluble or -insoluble, depending on bridging substituents and attached groups in the molecule. A general procedure to synthesize an acetal is to react an aldehyde with alcohol. For synthesizing an embodiment of an acetal crosslinking agent of the present invention, we can react an aromatic aldehyde with an alcohol containing ethylenically unsaturated groups in the presence of an acid catalyst. In some cases the ethylenically unsaturated groups can be added after the reaction of the alcohol with the aldehyde, as shown in U.S. Pat. No. 7,056,091. In addition to the acetals already described above as being suitable, bisacrylamide acetals, others are also suitable, including diketene acetals that have a functionality of two or more (i.e., two or more unsaturated groups), as described in U.S. Pat. Nos. 4,304,767 and 7,056,901, the entire disclosures of which are incorporated herein by reference.

Suitable ketal crosslinking agents are described in U.S. Pat. No. 5,191,015, the entire disclosure of which is hereby incorporated by reference, and are shown in Scheme 6A and 6B based on ethylene glycol monoacrylate ester and 2-maleimidyl ethanol, respectively.

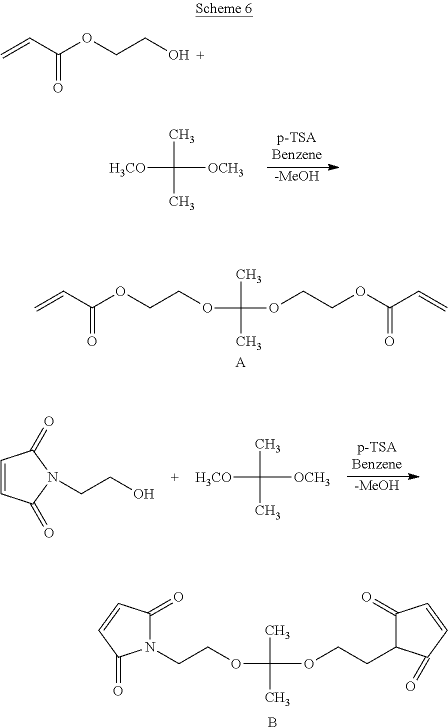

Because the degradable crosslinking agents have a degradable group, degradation of this bond in the degradable gel once formed may at least partially result in a degradation of the gel. The degradable group is capable of undergoing an irreversible degradation. The term “irreversible,” as used herein, means that a degradable crosslinking agent or a degradable gel of the present invention may degrade in situ (e.g., within a well bore) but may not reform in situ after degradation. The terms “degradation” and/or “degradable,” as used herein, refer to the conversion of materials into smaller components, intermediates, or end products by chemical processes such as hydrolytic degradation or by the action of biological entities, such as bacteria or enzymes. It refers to both heterogeneous (or bulk erosion) and homogenous (or surface erosion), and any stage of degradation between these two by action of water on the degradable group. This degradation may be the result of, inter alia, a chemical reaction, a thermal reaction, an enzymatic reaction, or a reaction induced by radiation. The degradability of the degradable gel used in the methods of the present invention depends, at least in part, on the backbone structure of the crosslinking agent. For instance, the presence of hydrolyzable and/or oxidizable linkages in the backbone often yields a degradable crosslinking agent that will degrade as described herein. The rates at which such crosslinking agents degrade may be dependent on the environment to which the degradable crosslinking agent and/or degradable gel is subjected, e.g., temperature, the presence of moisture, oxygen, microorganisms, enzymes, pH, and the like may affect the rate of degradation.

Among other things, as stated above, degradation of the crosslinking agent may be sensitive to pH and temperature. Without being bound by theory, with an increase in temperature, the hydrolysis of the degradable group may be faster. To reduce the pH of the treatment fluid at a desired time, a number of methods may be employed. In some embodiments, the treatment fluid may be contacted by an acid after introduction of the treatment fluid into the subterranean formation. Examples of suitable acids include, but are not limited to, hydrochloric acid, hydrofluoric acid, formic acid, phosphoric acid, sulfamic acid, and acetic acid, and derivatives thereof, and mixtures thereof. In other embodiments, a delayed-release acid, such as an acid-releasing degradable material or an encapsulated acid, may be included in the treatment fluid so as to reduce the pH of the treatment fluid at a desired time, for example, after introduction of the treatment fluid into the subterranean formation. Suitable encapsulated acids that may be included in the treatment fluids of the present invention include, but are not limited to, fumaric acid, formic acid, acetic acid, acetic anhydride, anhydrides, hydrochloric acid, and hydrofluoric acid, and combinations thereof, and the like. Exemplary encapsulation methodology is described in U.S. Pat. Nos. 5,373,901; 6,444,316; 6,527,051; and 6,554,071, the entire disclosures of which are incorporated herein by reference. Acid-releasing degradable materials also may be included in the treatment fluids of the present invention to decrease the pH of the fluid. Suitable acid-releasing degradable materials that may be used in conjunction with the present invention are those materials that are substantially water-insoluble such that they degrade over time, rather than instantaneously, to produce an acid. Examples of suitable acid-releasing degradable materials include lactones, polylactones, anhydrides, polyanhydrides, esters, polyesters, orthoesters, polyorthoesters, lactides, polylactides, glycolides, polyglycolides, substituted lactides wherein the substituted group comprises hydrogen, alkyl, aryl, alkylaryl, and acetyl, and mixtures thereof, substantially water-insoluble anhydrides, and poly(anhydrides), and mixtures and copolymers thereof. Materials suitable for use as an acid-releasing degradable material of the present invention may be considered degradable if the degradation is due, inter alia, to chemical processes, such as hydrolysis, oxidation, or enzymatic decomposition. The appropriate pH-adjusting agent or acid-releasing material and amount thereof may depend upon the formation characteristics and conditions, the particular orthoester-based surfactant chosen, and other factors known to individuals skilled in the art, with the benefit of this disclosure.

In some embodiments, the degradable crosslinking agents suitable for use in the present invention may be relatively easy to synthesize in large amounts, and may have good stability for long-term storage, especially in anhydrous conditions. Anhydrous conditions may be achieved as described herein above by way of azeotropic removal of water, freeze drying, and/or dispersing in a suitable solvent that is readily dried.

In one embodiment, a cross-linked gelling agent that has been cross-linked with a crosslinking reaction comprising a degradable crosslinking agent may be added to an aqueous treatment fluid (e.g., a pill, a fracturing fluid, or a gravel pack fluid), and then introduced into a subterranean formation. Suitable aqueous treatment fluids include freshwater, salt water, brine, seawater, or any other aqueous liquid that does not adversely react with the other components used in accordance with this invention or with the subterranean formation.

In some embodiments, the treatment fluid may be foamed. In some such embodiments, methods of the invention employ a treatment fluid that is foamed and comprises a surfactant. One advantage of using a foamed treatment fluid over a non-foamed version is that less of the aqueous fluid is used, relatively speaking. This may be important in subterranean formations that are water-sensitive or under pressure. In some embodiments, the foamed treatment fluids have a foam quality of about 30% or above. These may include commingled fluids. A preferred foam quality level is about 50% or above.

In some embodiments wherein the treatment fluid is foamed, the treatment fluid may comprise a surfactant. The choice of whether to use a surfactant will be governed at least in part by the mineralogy of the formation. As will be understood by those skilled in the art, anionic, cationic, nonionic, or amphoteric surfactants also may be used so long as the conditions they are exposed to during use are such that they display the desired foaming properties. For example, in particular embodiments, mixtures of cationic and amphoteric surfactants may be used. When used in treatment fluid embodiments, the surfactant is present in an amount of from about 0.01% to about 5% by volume. When foamed, the base fluid may comprise a gas. While various gases can be utilized for foaming the treatment fluids of this invention, nitrogen, carbon dioxide, and mixtures thereof are preferred. In examples of such embodiments, the gas may be present in a base fluid and/or a delayed tackifying composition in an amount in the range of from about 5% to about 95% by volume, and more preferably in the range of from about 20% to about 80%. The amount of gas to incorporate into the fluid may be affected by factors including the viscosity of the fluid and bottomhole pressures involved in a particular application. Examples of preferred foaming agents that can be utilized to foam the base fluid and/or the delayed tackifying composition of this invention include, but are not limited to, alkylamidobetaines such as cocoamidopropyl betaine, alpha-olefin sulfonate, trimethyltallowammonium chloride, C₈ to C₂₂ alkylethoxylate sulfate and trimethylcocoammonium chloride. Cocoamidopropyl betaine is especially preferred. Other suitable surfactants available from Halliburton Energy Services, Inc. include: “19NTM,” “G-SPERSE™ dispersant,” “MORFLO III®” surfactant, “HYFLO® IV M” surfactant, “PEN-88M™” surfactant, “HC-2™ Agent,” “PEN-88 HT™” surfactant, “SEM-7™” emulsifier, “HOWCO-SUDS™”, foaming agent, “A-SPERSE™” dispersing aid for acid additives, “SSO-21E™” surfactant, and “SSO-21MW™” surfactant. Other suitable foaming agents and foam-stabilizing agents may be included as well, which will be known to those skilled in the art with the benefit of this disclosure. The foaming agent is generally present in a treatment fluid of the present invention in an amount in the range of from about 0.01% to about 5%, by volume, more preferably in the amount of from about 0.2% to about 1%, and most preferably about 0.6% by volume.

Optionally, the treatment fluid may comprise a second gelling agent. Any gelling agent suitable for use in subterranean applications may be used in these treatment fluids, including, but not limited to, natural biopolymers, synthetic polymers, cross-linked gelling agents, viscoelastic surfactants, and the like. Guar and xanthan are examples of suitable gelling agents. A variety of gelling agents may be used, including hydratable polymers that contain one or more functional groups such as hydroxyl, carboxyl, sulfate, sulfonate, amino, or amide groups. Suitable gelling agents typically comprise polysaccharides, biopolymers, or synthetic polymers, or a combination thereof. Examples of suitable polymers include, but are not limited to, guar gum and derivatives thereof, such as hydroxypropylguar and carboxymethylhydroxypropylguar, cellulose derivatives, such as hydroxyethylcellulose, locust bean gum, tara, konjak, tamarind, starch, karaya, diutan, scleroglucan, wellan, gellan, xanthan, tragacanth, and carrageenan, and derivatives of all of the above. Additionally, synthetic polymers and copolymers may be used. Examples of such synthetic polymers include, but are not limited to, polyacrylate, polymethacrylate, polyacrylamide, polyvinyl alcohol, and polyvinylpyrrolidone. In other exemplary embodiments, the gelling agent molecule may be depolymerized. The term “depolymerized,” as used herein, generally refers to a decrease in the molecular weight of the gelling agent molecule. Depolymerized gelling agent molecules are described in U.S. Pat. No. 6,488,091, the entire disclosure of which is incorporated herein by reference. Suitable gelling agents generally may be present in the compositions of the present invention in an amount in the range of from about 0.1% to about 5% by weight of the water therein.

Combinations of surfactants may be used in the present invention so that they form elongated or rod-like micelles or structures that can control the viscosity of a well bore treatment fluid. While these systems may lead to good filter cake cleanup, their fluid loss control power may be considered poor. However, addition of degradable gel particles to viscoelastic surfactants gives much improved fluid loss control while maintaining good filter cake removal. Combinations of surfactants that have an average packing factor of between about ⅓ to ½ are thought to give good viscosity control. Examples include combinations of betaines and fatty acids.

If a second gelling agent is used, a suitable breaker may be necessary to ultimately reduce the viscosity of the fluid to a desirable extent or any undesirable resulting gel residue. Any breaker suitable for use in the subterranean formation and with the gelling agent may be used. The amount of a breaker to include will depend, inter alia, on the amount of gelling agent present in the treatment fluid or the amount of gel residue present in the formation. Other considerations regarding the breaker are known to one skilled in the art with the benefit of this disclosure.

A treatment fluid may comprise proppant or gravel particulates, as needed. Any proppant or gravel particulates that are suitable for use in subterranean applications may be used in the treatment fluids of the present invention.

To delay the degradation of a degradable crosslink or a degradable gel, an inhibitor may be included in the gel. Suitable inhibitors include bases. Examples of some preferred inhibitors may include metal hydroxides, potassium hydroxide, amines such as hexamethylenetetramine, and sodium carbonate, and combinations thereof. In certain embodiments, a small amount of a strong base, such as urea, as opposed to a large amount of a relatively weak base is preferred to achieve the delayed degradation.

In some embodiments, the degradable gels of the present invention may be used as or in conjunction with fluid loss control pills. A “fluid-loss control pill” is a gelled fluid that is designed or used to provide some degree of fluid-loss control. Through a combination of viscosity, solids bridging, and cake buildup on the porous rock, these pills oftentimes are able to reduce fluid loss from portions of a formation. They also generally enhance filter-cake buildup on the face of the formation to inhibit fluid flow into the formation from the well bore.

In some embodiments, degradable cross-linking agents may be used to form degradable cross-linked fluid loss control agents that comprise degradable gel particles. These fluid loss control agents can be added to any treatment fluid wherein it is desirable to control fluid loss.

Two methods of making degradable gel particles include forming an emulsion, or forming a large gel and chopping up the cross-linked polymer. An embodiment of the emulsion method consists of forming a water-in-oil emulsion with appropriate surfactants, an appropriate initiator, a degradable crosslinking agent, and chosen monomers to form the gelling agent. This emulsion can be heated to initiate polymerization in the water phase. When polymer formation is complete, the gel particles can be dried by azeotropic distillation and recovered by either filtration or centrifugation or crashed in acetone followed by filtration and vacuum-drying. Alternatively, a macroscopic gel can be formed by copolymerizing the crosslinking agent with the gelling agent monomers in an appropriate solvent. The resultant gel can then be chopped up into smaller particles as desired using a high speed shearing device such as a Waring blender. A pourable dispersion of gel particles may result.

Although this invention has been described in terms of some specific uses of the degradable crosslinking agents and degradable gels of the present invention, these may be used in other applications, as recognized by one of skill in the art with the benefit of this disclosure.

To facilitate a better understanding of the present invention, the following example of preferred or representative embodiments are given. In no way may the following examples be read to limit, or to define, the scope of the invention.

### Example

Crosslinked polyacrylamide materials were synthesized in the laboratory by suspension polymerization with 30% active polymer (31.15% water and 34.68% oil). The molar ratio of acrylamide and poly(ethylene glycol)diacylate (MW 700) was 146:1. When the reaction was complete, the reaction mixture was treated in two different ways to get wet or dry particulates for thermal stability testing. Sample A was filtered through a Buchner Funnel as the wet particles, while sample B was made as dehydrated particulates by crashing into acetone then the precipitates were washed a few times with acetone followed by vacuum-drying. In order to differentiate the thermal stability of the two samples, both of them (wet or dehydrated) were treated at 131° F./55° C. for 1 week, 2 weeks and 6 weeks. Each treated sample was dispersed into Houston tap water and viscosity was measured by Haake with Rotor z20 at 40 s⁻¹ for all the samples. The dispersion of wet Sample A was made with 4 grams of wet particulates in 100 mL of tap water; the dispersion of dry Sample B was made with 2 grams of dry particulate in 100 mL of tap water. The percentage of viscosity changes were recorded in Table 1. The viscosity of wet Sample A which was heated at 131° F./55° C. for 1 week, 2 weeks did not change much compared to the untreated sample, while after treated for 6 weeks, the viscosity increased 31% which indicating the degradation of the acrylate crosslinkers and allowing the polyacrylamide polymer chains go into solution. The viscosity of dry Sample B after heated at 131° F./55° C. for 6 weeks did not show much viscosity change which indicated that there is not much degradation after 6 weeks of treatment.

TABLE 1
Viscosity of treated crosslinked polyacrylamide (wet/dehydrated)
dispersed in 100 mL of Houston tap water.

| Sample | Treating Time | | Viscosity |
|---|---|---|---|
| List | (weeks) at 55° C. | Viscosity (cp) at 40 s⁻¹ | Change (%) |
| Sample A | 0 | 41.6 | 0 |
| | 1 | 42.4 | 1.9 |
| | 2 | 42.9 | 3.1 |
| | 6 | 54.5 | 31.0 |
| Sample B | 0 | 40.0 | 0 |
| | 1 | 40.6 | 1.5 |
| | 2 | 40.5 | 1.3 |
| | 6 | 41.0 | 2.5 |

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification may be adopted.

The invention claimed is:

1. A method comprising:
providing a dehydrated gel as a solid or dispersion;
wherein the dehydrated gel is formed by a combination of a monomer, and a degradable crosslinking agent of formula:
R¹-[A]-[R³]—[B]—R²
wherein R¹ and R² may be the same or different, and comprise at least one group selected from the group consisting of: a substituted or unsubstituted ethylenically unsaturated group, N-acryloyl, O-acryloyl, vinyl, allyl, maleic anydride, a derivative thereof, and a combination thereof; A and B comprise optional bridging units; and R³ comprises a degradable group or polymer;
placing the dehydrated gel in an aqueous base fluid thereby forming a treatment fluid comprising a degradable gel; and
placing the treatment fluid into a subterranean formation.

2. The method of claim 1, wherein the monomer comprises at least one selected from the group consisting of an ethylenically unsaturated monomer of the general formula: CH₂═CXY, wherein X and Y may be hydrogen, methyl, an alkoxy amide group, or an acetamide group; an ionizable monomer; 1-N,N-diethylaminoethyl methacrylate; diallyldimethylammonium chloride; 2-acrylamido-2-methylpropanesulfonic acid; acrylic acid; sodium 2-acrylamido-2-methylpropanesulfonate; acrylic acid; sodium acrylate; an allylic monomer; diallyl phthalate; diallyl maleate; allyl diglycol carbonate; vinyl formate; vinyl acetate; vinyl propionate; vinyl butyrate; itaconic acid; acrylamide; methacrylamide; methacrylonitrile; acrolein; methyl vinyl ether; ethyl vinyl ether; vinyl ketone; ethyl vinyl ketone; allyl acetate; allyl propionate; diethyl maleate; a vinyl amide; N-vinylpyrrolidone, N-vinylformamide, N-vinylacetamide, N-vinylcaprolactam; a derivative thereof; and any combination thereof.

3. The method of claim 1, wherein R³ comprises at least one group selected from the group consisting of: an ester, a phosphate ester, an amide, an acetal, a ketal, an orthoester, a carbonate, an anhydride, a silyl ether, an alkene oxide, an ether, an imine, an ether ester, an ester amide, an ester urethane, a carbonate urethane, an amino acid, a derivative thereof, and any combination thereof.

4. The method of claim 1, wherein an elastic modulus of the gel particles at a first time is greater than the elastic modulus of the gel particles at a later second time due to degradation of the degradable gel.

5. The method of claim 1 wherein A or B comprises, independently, at least one group selected from the group consisting of: a peptide chain, an aromatic substituent, an alkyl group, an alkylene oxide group, a polar group, and a derivative thereof.

6. The method of claim 1, wherein the degradable crosslinking agent is synthesized from diketene acetals or multiketene acetals by the addition of an alcohol having acrylic, vinylic, or allylic groups.

7. The method of claim 6, wherein the alcohol comprises at least one alcohol selected from the group consisting of: hydroxyethyl acrylate; hydroxypropyl methacrylamide; hydroxybutyl methacrylate; and glycerol monomethacrylate.

8. The method of claim 1, wherein the degradable crosslinking agent is formed by a reaction comprising an alcohol that contains a vinyl, allyl, or acryloyl group and a low molecular weight orthoester of Formula I: 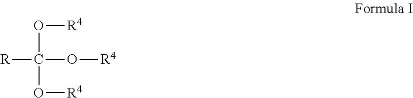
wherein R is H, CH₃, or C₂H₅, and each R⁴ is, independently, an alkyl group having from about 1 to about 6 carbon atoms.

9. The method of claim 1, wherein the degradable crosslinking agent is water soluble.

10. The method of claim 1, wherein the treatment fluid is foamed and comprises a surfactant.

11. A method comprising:
providing a dehydrated gel as a solid or dispersion;
wherein the dehydrated gel is formed by reacting a monomer and a degradable crosslinking agent that includes at least one degradable group and two unsaturated terminal groups to provide a crosslinked gel product and dehydrating the crosslinked gel product;
placing the dehydrated gel in an aqueous base fluid thereby forming a treatment fluid comprising a degradable gel;
placing the treatment fluid into a subterranean formation; and
allowing the degradable gel to degrade.

12. The method of claim 11, further comprising reducing the pH of the treatment fluid before allowing the degradable gel to degrade.

13. The method of claim 11, further comprising subjecting the treatment fluid to a temperature change before allowing the degradable gel to degrade.

14. The method of claim 11, wherein the degradable group comprises at least one degradable group selected from the group consisting of: an ester, a phosphate ester, an amide, an acetal, a ketal, an orthoester, a carbonate, an anhydride, a silyl ether, an alkylene oxide, an ether, an imine, an ether ester, an ester amide, an ester urethane, a carbonate urethane, an amino acid, a derivative thereof, and a combination thereof.

15. The method of claim 11, wherein an elastic modulus of the treatment fluid is reduced upon degradation of the degradable gel.

16. The method of claim 11, wherein at least one of the unsaturated terminal groups comprises at least one group selected from the group consisting of: a substituted or unsubstituted ethylenically unsaturated group, a vinyl group, an allyl group, an acryloyl group, an unsaturated ester, an acrylate, a methacrylate, a butyl acrylate, an amide, an acrylamide, an ether, a vinyl ether, a combination thereof, and a derivative thereof.

17. The method of claim 11, wherein the monomer comprises at least one gelling agent selected from the group consisting of: an ethylenically unsaturated monomer of the general formula: CH₂═CXY, wherein X and Y may be hydrogen, methyl, an alkoxy amide group, or an acetamide group; an ionizable monomer; 1-N,N-diethylaminoethyl methacrylate; diallyldimethylammonium chloride; 2-acrylamido-2-methylpropanesulfonic acid; acrylic acid; sodium 2-acrylamido-2-methylpropanesulfonate; acrylic acid; sodium acrylate; an allylic monomer; diallyl phthalate; diallyl maleate; allyl diglycol carbonate; vinyl formate; vinyl acetate; vinyl propionate; vinyl butyrate; itaconic acid; acrylamide; methacrylamide; methacrylonitrile; acrolein; methyl vinyl ether; ethyl vinyl ether; vinyl ketone; ethyl vinyl ketone; allyl acetate; allyl propionate; diethyl maleate; a vinyl amide; N-vinylpyrrolidone, N-vinylformamide, N-vinylacetamide, N-vinylcaprolactam; a derivative thereof; and any combination thereof.

18. The method of claim 17, wherein at least one of the unsaturated terminal groups comprises at least one group selected from the group consisting of: a substituted or unsubstituted ethylenically unsaturated group, a vinyl group, an allyl group, an acryloyl group, an unsaturated ester, an acrylate, a methacrylate, a butyl acrylate, an amide, an acrylamide, an ether, a vinyl ether, a combination thereof, and a derivative thereof.

19. The method of claim 17, wherein the monomer comprises at least one gelling agent selected from the group consisting of: an ethylenically unsaturated monomer of the general formula: CH₂═CXY, wherein X and Y may be hydrogen, methyl, an alkoxy amide group, or an acetamide group; an ionizable monomer; 1-N,N-diethylaminoethyl methacrylate; diallyldimethylammonium chloride; 2-acrylamido-2-methylpropanesulfonic acid; acrylic acid; sodium 2-acrylamido-2-methylpropanesulfonate; acrylic acid; sodium acrylate; an allylic monomer; diallyl phthalate; diallyl maleate; allyl diglycol carbonate; vinyl formate; vinyl acetate; vinyl propionate; vinyl butyrate; itaconic acid; acrylamide; methacrylamide; methacrylonitrile; acrolein; methyl vinyl ether; ethyl vinyl ether; vinyl ketone; ethyl vinyl ketone; allyl acetate; allyl propionate; diethyl maleate; a vinyl amide; N-vinylpyrrolidone, N-vinylformamide, N-vinylacetamide, N-vinylcaprolactam; a derivative thereof; and any combination thereof.

20. A method comprising:
placing a dehydrated gel as a solid or dispersion in an aqueous base fluid to provide degradable crosslinked gelled particles;
wherein the dehydrated gel is formed by a reaction comprising a monomer, and a degradable crosslinking agent that includes at least one degradable group and two unsaturated terminal groups;
introducing the degradable crosslinked gelled particles into a subterranean formation; and
allowing the degradable crosslinked gelled particles to reduce the loss of fluid to a portion of the subterranean formation.
